(19) United States
(12) Patent Application Publication
(10) Pub. No.: US 2004/0044664 A1
(43) Pub. Date: Mar. 4, 2004

(54) Systems and methods for applying customer DNA to airline service and customer relationship management environments

(75) Inventors: Eddie Cash, Carrollton, TX (US); Anomah Ngu, Keller, TX (US); Rudy DeWulf, Coppell, TX (US); Mark Whitman, Grapevine, TX (US); Ceryl T. Medua, Grapevine, TX (US); Robert C. Murphy, Colleyville, TX (US); Karen D. Carter, Southlake, TX (US); Rhadee Resma, Southlake, TX (US); Richard Mervin Sharp, Grapevine, TX (US); Brian Harry Wong, Flower Mound, TX (US); Claudia Lucille Woodruff, North Richland Hills, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Sabre Inc., Southlake, TX

(21) Appl. No.: 10/441,449

(22) Filed: May 20, 2003

Related U.S. Application Data
(63) Continuation-in-part of application No. 09/902,184, filed on Jul. 10, 2001.
(60) Provisional application No. 60/381,384, filed on May 20, 2002.

(51) Int. Cl. G06F 7/00

(52) U.S. Cl. 707/9

(57) ABSTRACT

A method, system and computer for sharing customer information, such as travel-based information, among a plurality of electronic storage facilities are provided. The travel-based information may include at least one of a travel profile, current trip information, customer service incident information, customer contact log data, customer service suggestion information, and prior trip information associated with the traveler. The travel-based information stored by the various storage facilities is cross-referenced by an identifier that is associated with a respective traveler and is maintained by a master data store. By accessing the travel-based information cross-referenced by a respective identifier, a comprehensive view of the travel-based information associated with the traveler designated by the respective identifier may be provided.

### CROSS-REFERENCE TO RELATED APPLICATION(S)

The present application claims priority from U.S. Provisional Application No. 60/381,384, filed May 20, 2002, and is a continuation-in-part of U.S. application Ser. No. 09/902,184, filed Jul. 10, 2001, the contents of each of which are incorporated herein in their entirety.

### DESCRIPTION OF THE INVENTION

1. Field of the Invention

The present invention relates to systems and methods for indexing information to facilitate the sharing of data between electronic storage facilities.

2. Background of the Invention

In a business there may exist multiple electronic storage facilities (e.g., databases) for storing information on customers. For example, a company that provides multiple services to customers may have separate electronic storage facilities for each service provided to store customer information. As another example, a company with multiple locations may have separate electronic storage facilities at each company location.

Oftentimes, the storage facilities within a company duplicate information and have no capability for sharing data. Therefore, when there is a need to update information, each storage facility must be accessed individually. Furthermore, the inability to share information limits the ability of a company to consolidate customer information and fully exploit targeted marketing opportunities as well as to provide optimal customer service.

In addition, the inability of separate companies to efficiently share customer information with each other further limits their opportunities to consolidate customer information for targeted marketing opportunities. That is, separate businesses may store different information on the same customers. It would be advantageous if companies could efficiently share customer information.

Consolidating data from multiple storage facilities into a single storage facility would take tremendous effort and require massive disk space. Therefore, it is desirable to provide a system and method for accessing information across multiple storage facilities.

The reliable storage and access of customer information is a valuable tool for customer relationship management. By way of example, today's airline managers understand the ideals of Customer Relationship Management, or CRM, and its importance in building long term customer relationships. Getting to know and understand customers is essential. Therefore, it is critical that the airlines be able to obtain and store customer information, including general preferences and past travel experiences, and to make that information readily available to agents. Exemplary types of customer information that would be valuable to a travel agent and others include: traveler profiles, current trips, prior trips, customer service incidents, customer contact logs, customer service suggestions and pre-scripted customer service talking points. To date, however, these various types of customer information have generally been stored, if at all, in separate databases that were not cross-referenced and that had to be separately accessed, thereby undesirably slowing the customer information retrieval process and failing to provide an overview or summary of the customer information.

### SUMMARY OF THE INVENTION

In accordance with one advantageous aspect of the present invention, a method for sharing customer information, such as travel-based information, among a plurality of electronic storage facilities is provided. The travel-based information may include at least one of a travel profile, current trip information, customer service incident information, customer contact log data, customer service suggestion information, and prior trip information associated with the traveler. The method comprises receiving travel-based information associated with and identifying a customer from an electronic storage facility and determining whether an identifier exists in a master data store for the traveler based on the travel-based information. The method further comprises associating an identifier with the traveler based on a result of the determination and cross-referencing the identifier with the travel-based information. A computer and a corresponding system for implementing the method of sharing travel-based information are also provided.

According to another advantageous aspect of the present invention, a method for sharing travel-based information among a plurality of electronic storage facilities is provided in which an inquiry for travel-based information associated with a traveler is initially received. The travel-based information may again include at least one of a travel profile, current trip information, customer service incident information, customer contact log data, customer service suggestion information, and prior trip information associated with the traveler. The method comprises determining whether an identifier exists in a master data store for the traveler based on the travel-based information, and subsequently providing access to travel-based information associated with the traveler and stored in a respective storage system based upon the identifier for the traveler and the travel-based information cross-referenced by the master data store to the identifier. A corresponding system for implementing the method of sharing travel-based information is also provided.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate one embodiment of the invention and together with the description, serve to explain the principles of the invention.

FIG. 1 illustrates an environment for practicing the present invention.

FIG. 2 illustrates an exemplary MDNA index.

FIG. 3 illustrates a method of assigning a CDNA ID.

FIG. 4 illustrates a method of retrieving data source IDs and corresponding customer IDs.

FIG. 5 illustrates exemplary customer information stored at an electronic storage facility.

FIG. 6 illustrates a method of deleting a customer ID from the MDNA index.

FIG. 7 illustrates an exemplary state of an MDNA index.

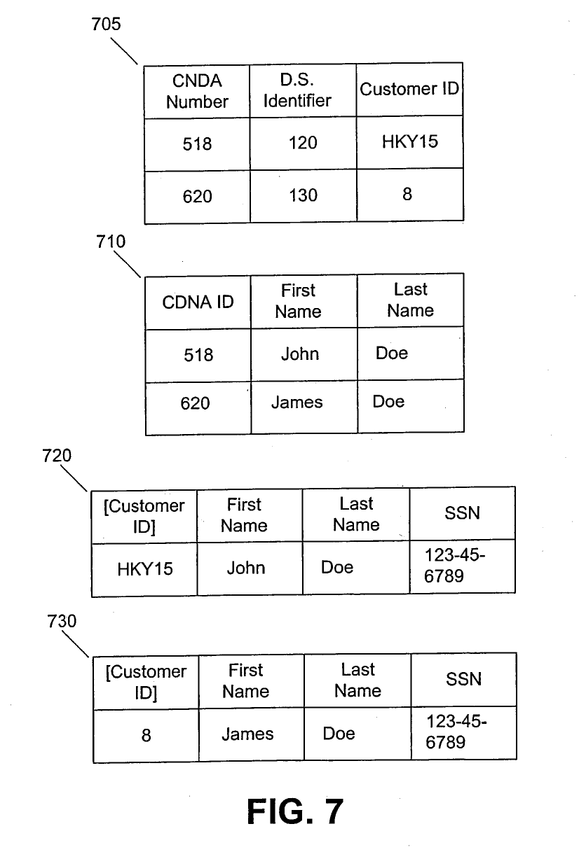

FIG. 8 is a schematic representation of various types of traveler information that may be cross-referenced in accordance with one embodiment of the present invention.

FIG. 9 is a schematic representation exemplifying the traveler information that may be provided in accordance with the embodiment of FIG. 8.

FIG. 10 is a block diagram of an exemplary system environment in accordance with one embodiment of the present invention.

FIG. 11 is a schematic representation of various uses of the customer information which is provided by a number of different data sources.

### DESCRIPTION OF THE EMBODIMENTS

Reference will now be made in detail to the present embodiment of the invention, an example of which is illustrated in the accompanying drawings. Wherever possible, the same reference numbers will be used throughout the drawings to refer to the same or like parts.

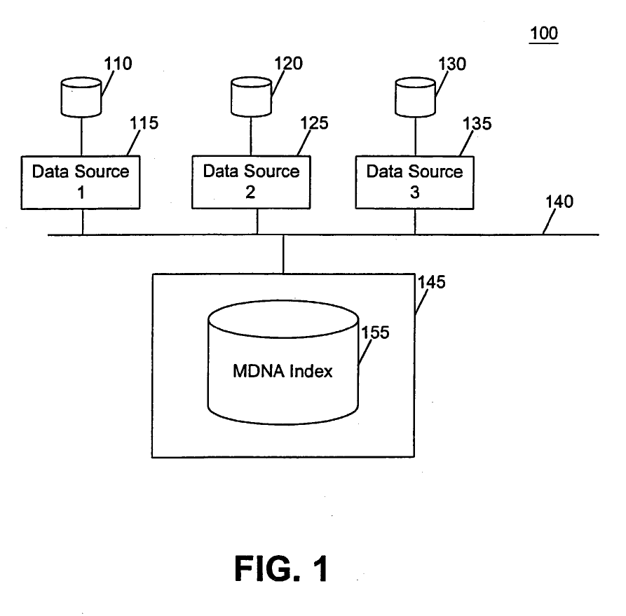

FIG. 1 illustrates an environment 100 in which to practice the method of the present invention. The environment 100 comprises multiple electronic storage facilities 110, 120, 130 for storing customer information. The customer information may be stored by a company that maintains multiple storage facilities. In this case, data sources 115, 125, and 135 may correspond to separate business units within a company. Alternatively, data sources 115, 125, and 135 may correspond to multiple companies that desire to share information with each other. The data sources 115, 125, and 135 are connected via a communication link 140, which also connects the data sources 115, 125,135 to a CDNA system 145. In an alternate embodiment, the data sources 115, 125, and 135 and the CDNA system 145 may be connected using communications techniques used to provide wireless transmission, for example, satellite. Furthermore, the data sources 115, 125, 135, and the CDNA system 145 may communicate via a CORBA (Common Object Request Broker Architecture) framework.

The CDNA system 145 of the present invention creates one central repository, the master DNA (MDNA) index 155, which enables multiple intra- and/or inter-company electronic storage facilities 110, 120, 130 to share data by assigning to each customer and storing in the master DNA (MDNA) index 155 a unique identification number (i.e., a customer DNA (CDNA) number). Each data source also assigns to each customer and stores in the corresponding electronic storage facility a unique identification number (i.e., a customer ID) for uniquely identifying the customer information stored in the electronic storage facility. Furthermore, each electronic storage facility is identified by a data storage identifier, i.e., data storage ID.

For each electronic storage facility that stores customer information, the master DNA (MDNA) index 155 cross references the CDNA ID of the customer with the data storage ID and corresponding customer ID for retrieving the customer information stored in the electronic storage facility. As mentioned above, the customer ID uniquely identifies the customer information stored in the electronic storage facility. For example, when an electronic storage facility stores customer information in a database, a primary key uniquely identifies the customer information and therefore may serve as the customer ID in the CDNA system 145. The CDNA system 145 of the present invention may also cross-reference the CDNA ID of a customer with other information (e.g., name, address, credit card number, phone number, email address, etc.) regarding the customer.

Because of disk space concerns and data coordination concerns, the MDNA index 155 does not store all the information on a customer that the electronic storage facilities 110, 120, 130 may store on the customer. Instead, the MDNA index 155 stores enough information to allow for the retrieval of the desired information from the electronic storage facilities 110, 120, 130, as described below in greater detail. As stated above, the MDNA index 155 may also store other information about a customer to serve as a definitive source of common data about the customer (e.g., address, phone number, email, etc.).

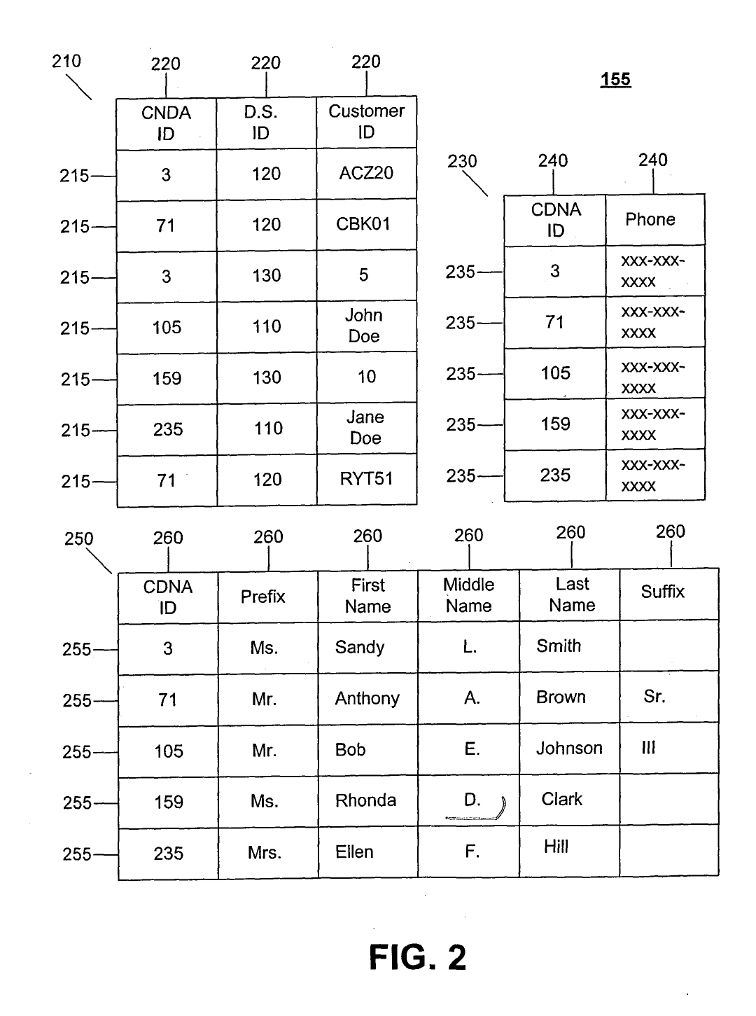

FIG. 2 illustrates an exemplary MDNA index 155 comprising multiple tables 210, 230, 250 consisting of multiple records 215, 235, 255, having multiple fields 220, 240, 260, respectively. A method for building a MDNA index 155 will be described in greater detail below. Each record in a table consists of information about a particular customer. For example, each record in the Cross Reference Table 210 consists of the storage location of information on a customer. For instance, information on a customer with a CDNA ID of 3 is stored in electronic storage facility 120; information on a customer with a CDNA ID of 105 is stored in electronic storage facility 110, and so on.

Furthermore, each record in table 210 provides the customer ID for retrieving the customer information from the electronic storage facility where the customer information is stored. For example, table 210 illustrates that customer ID “CBK01” will retrieve information on a customer with a CDNA ID of 71 from electronic storage facility 120.

Still further, there may be multiple records with the same CDNA ID. This may occur because information regarding a customer is stored in multiple electronic storage facilities. This may also occur because the customer may be identified by more than one customer ID within the same electronic storage facility. As shown in table 210, there exist two records for a customer corresponding to a CDNA ID of 3, indicating that information on the customer is stored in multiple electronic storage facilities identified by data storage identifiers 120 and 130. Furthermore, there exists two records for a customer with a CDNA ID of 71, indicating that information on the customer is stored in a single electronic storage facility 120 under two different customer IDs, i.e., CBK01 and RYT51.

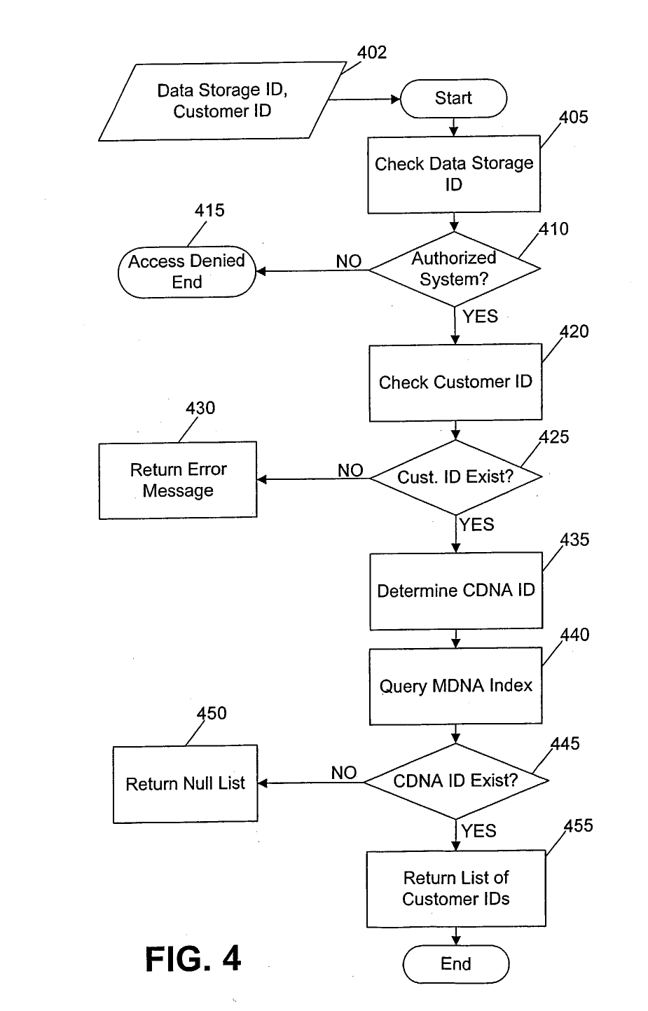

When a request for information is received, the CDNA system 145 may use table 210 stored in the CDNA index 155 to determine where information on a customer is stored and returns the customer ID provided by table 210. Information on the customer may then be retrieved from the electronic storage facility storing the customer information using the customer ID. A method for retrieving information from the CDNA index 155 will be discussed in greater detail below with reference to FIG. 4. By providing a table that provides information on where customer information is stored and further providing information on how to retrieve the customer information, the CDNA system 145 is able to facilitate the sharing of data between multiple electronic storage facilities.

That the CDNA system 145 facilitates the sharing of data between multiple electronic storage facilities is illustrated by the following example. If information on a particular customer (e.g., customer “A”) is stored in electronic storage facility 120 and information on another customer (e.g., customer “B”) is stored in data source 110, the CDNA system 145 can facilitate the sharing of this data by first generating a CDNA ID, e.g., 71, for customer A and a CDNA ID, e.g., 235, for customer B and storing these CDNA IDs in the MDNA index 155, as shown in FIG. 2. The CDNA system 145 further stores in the MDNA index 155 the customer IDs needed to retrieve the customer information stored in the electronic storage facilities. That is, if customer ID “CBK01” retrieves information regarding customer A stored in electronic storage facility 120, then, as illustrated in FIG. 2, the MDNA index 155 cross references with customer A, having a CDNA ID of 71, the electronic storage facility that contains information on customer A and the corresponding customer ID for retrieving information on customer A stored in the electronic storage facility. Similarly, the MDNA index 155 cross references with customer B, having a CDNA ID of 235, the electronic storage facility that contains information on customer B and the corresponding customer ID for retrieving information on customer B stored in the electronic storage facility. Based on the information stored in the MDNA index 155 of FIG. 2, it is readily determined that information on customer A, having a CDNA ID of 71, is stored in data source 120. Similarly, it is readily determined that information on customer B, having a CDNA ID of 235, is stored in data source 110. To access the information on customer A stored in data source 120, the CDNA system 145 provides the data source identifier 120 and the customer ID CBK01. To access the information on customer B stored in data source 140, the CDNA system 145 provides the data source identifier 110 and the customer ID, “Jane Doe.”

Since the CDNA index 155 may further cross-reference the CDNA ID of a customer with other core information (e.g., name, address, etc.) regarding the customer, the MDNA index 155 may comprise additional tables such as a Customer Name Table 250 and a Customer Phone Table 230 as shown in FIG. 2. Other tables may also exist in the MDNA index 155. For example, a customer address table that cross-references a CDNA ID with an address may exist in the IVIDNA index 145. Fields of the customer address table may include a street number field, a street name field, a city name field, a state name field, and a zip code field. In addition, a customer email table or a customer credit card table may exist in the MDNA index 155. The customer email table may cross-reference a CDNA ID with an email address. The customer credit card table may cross-reference a CDNA ID with a credit card number.

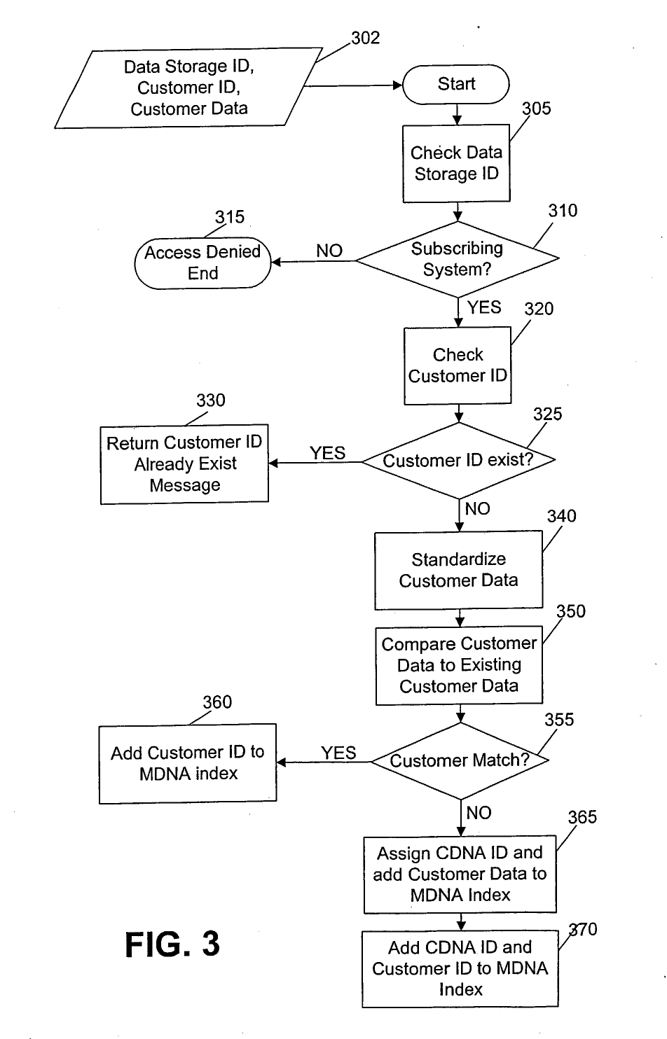

As discussed above, the CDNA system 145 assigns a unique identification number, a CDNA ID, to each customer referenced in the IVIDNA index 155. Once a CDNA ID has been assigned to a customer, that number is thereafter used to reference data associated with that customer in the IVIDNA index 155. FIG. 3 illustrates an exemplary method of generating a CDNA ID. The process of creating a CDNA ID begins when a data source 115, 125, 135 makes a request 302 to add a customer ID number to the MDNA index 155 by supplying its data storage ID, the customer ID, and customer data to the CDNA system 145. The data storage ID is an identifier for the requesting system. The customer data may consist of attributes such as the customer's name and address.

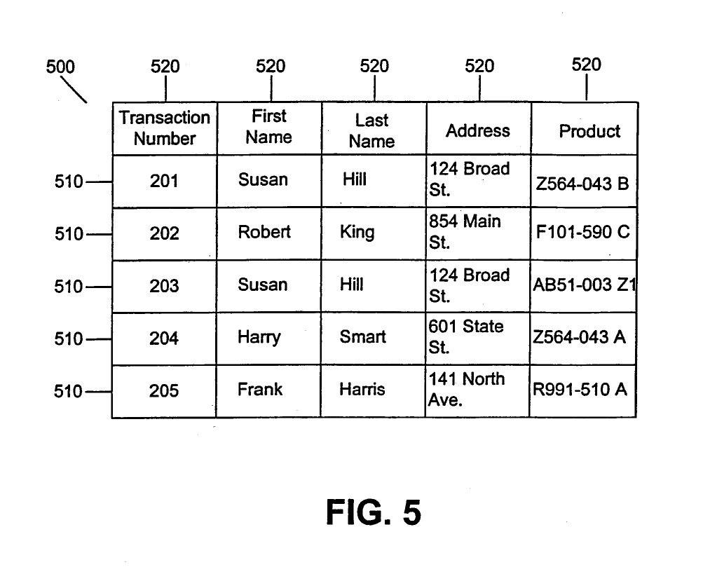

The request to add a customer ID to the MDNA index 155 may be initiated after the data source 115, 125, 135 stores new information regarding a customer in its electronic storage facility. For example, some data sources 115, 125, 135 assign different customer IDs each time a customer completes a transaction. For instance, a company that sells products may assign a new customer ID number each time a product is sold, regardless of whether a customer purchasing the product has previously purchased a product from the company. Therefore, each time the same customer buys a product from the company, the company assigns a new customer ID number for the transaction, even though the customer is the same. Thus, a customer may have several different customer IDs corresponding to the customer stored in a company's electronic storage facility. FIG. 5 illustrates an exemplary table 500 which may be stored in an electronic storage facility. The table consists of records 510, having indexes 520. Each record corresponds to a new transaction, i.e., the sale of a product. Therefore, each time a customer purchases a product, the company stores in its electronic storage facility 110, 120, 130 a record having a transaction number, the customer's name and address, and the product sold, for example. Each time a record in created, the company requests storage of the transaction number, i.e., the customer ID, in the MDNA index 155. As illustrated in FIG. 5, the same customer may have multiple customer IDs. For example, customer “Susan Hill” has customer IDs 201 and 203. Other data sources 115, 125, 135 may provide one customer ID for the same customer and update information on the customer referencing the customer ID.

At steps 305 and 310, the CDNA system 145 checks the data storage ID to determine whether the requesting system is an authorized system. If the requesting system is not an authorized system, i.e., “NO” at step 310, the CDNA system 145 denies access to the MDNA index 155. If the requesting system is an authorized system, i.e., “YES” at step 310, then the CDNA system 145 checks the customer ID to determine whether the customer ID exists in the MDNA index 155 at step 320. If the customer ID already exists in the MDNA index 155, i.e., “YES” at step 325, then the CDNA system 145 returns a message informing the requesting system that the customer ID already exists.

If the customer ID does not exist in the MDNA index 155, i.e., “NO” at step 325, then the CDNA system 145 transforms and cleans the customer data to a standardized form at step 340. For example, assume a data source supplies customer data that reads: “123 Main St. Apt. 354.” The CDNA system 145 may transform and clean the customer data to read: “123 Main Street 354.” As another example, assume a data source supplies customer data including a phone number that reads: “1-(234)-567-8901.” The CDNA system 145 may transform and clean the phone number to read: “12345678901. At step 350, the CDNA system 145 compares the standardized customer data with existing customer data in the MDNA index 155 to determine whether a CDNA ID exists for the customer. The standardizing and comparison process may be performed using Trillium.

If the CDNA system 145 matches the standardized customer data with customer data already existing in the CDNA index 155, i.e., “YES” at step 355, then the CDNA ID is retrieved for that customer and cross-referenced in the MDNA index 155 with the data storage ID and customer ID provided by the requesting system at step 360. For example, the CDNA system 145 may create a record in table 210, for example, using the CDNA ID retrieved and the data storage ID and customer ID provided by the requesting system.

If there is no match, i.e., “NO” at step 355, then the standardized customer data is added to the MDNA index 155 and the CDNA system 145 assigns a CDNA ID for the customer at step 365. A CDNA ID may be assigned sequentially or may be derived using an algorithm based on the customer data, for example. The CDNA ID and the customer ID are then cross referenced in the MDNA index 145 at step 370. An exemplary program specification for performing the above steps is illustrated in the appendix by an addindex( ) function.

The MDNA index is continually updated each time a subscribing data source creates and stores a new customer ID or other information related to a customer. A subscribing data source is a data source 115, 125, 135 that has authority to add data to and retrieve data from the MDNA index 155. Each time a subscribing data source creates and stores a new customer ID or other information, the data source transmits information to the CDNA system 145 for storage in the MDNA index 155. If a CDNA ID already exists for a customer, then the CDNA systems cross-references the CDNA ID in the MDNA index 155 with the data source ID and the customer ID provided by the requesting system, i.e., step 360 in FIG. 3.

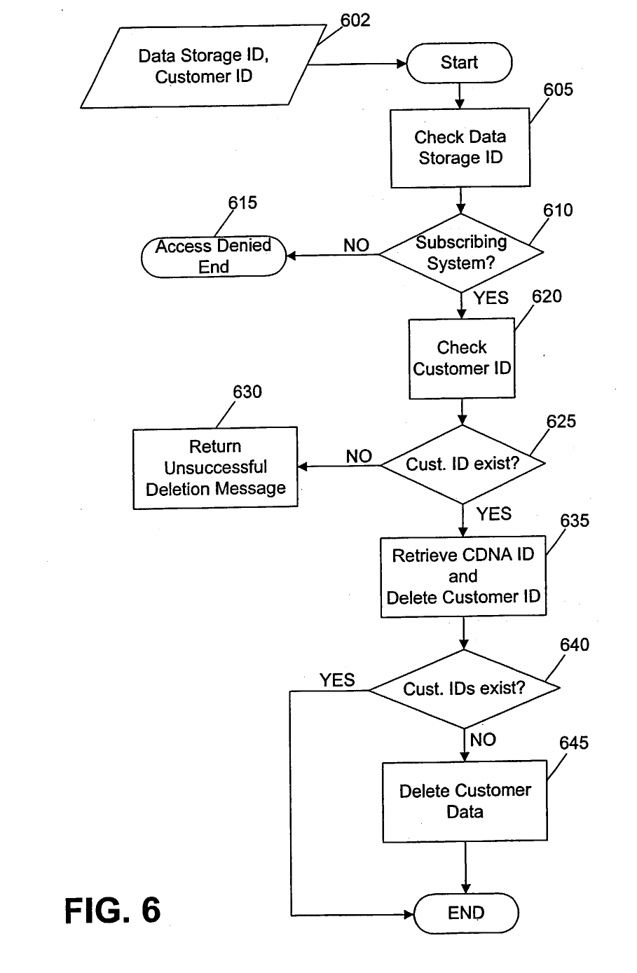

A subscribing data source may also request to delete a customer ID from the MDNA index 155. As illustrated in FIG. 6, a data source initiates a delete request by transmitting its data storage ID and the customer ID to be deleted to the CDNA system 145. At steps 605 and 610, the CDNA system 145 checks the data storage ID to determine whether the requesting system is an authorized system. If the requesting system is not an authorized system, i.e., “NO” at step 610, the CDNA system 145 denies access to the MDNA index 155. If the requesting system is an authorized system, i.e., “YES” at step 610, then the CDNA system 145 checks the customer ID to determine whether the customer ID exists in the MDNA index 155 at step 620. If the customer ID does not exist in the MDNA index 155, i.e., “NO” at step 625, then the CDNA system 145 returns a message to the requesting data source that the deletion was unsuccessful at step 630. If the customer ID exists in the MDNA index 155, i.e., “YES” at step 625, then the CDNA system 145 retrieves the CDNA ID and deletes the customer ID from the MDNA index 155 at step 635.

Processing proceeds to step 640, where the CDNA system 145 uses the CDNA ID, to determine whether other customer IDs are cross-referenced with the CDNA ID in the MDNA index 155. If there are no other customer IDs, i.e., “NO” at step 640, then the customer data associated with the CDNA ID is deleted from the MDNA index 155. If there exists other customer IDs, i.e., “YES” at step 640, then the other customer IDs and other customer data stored in the MDNA index 155 are retained and processing ends. An exemplary program specification for performing the above steps is illustrated in the appendix by a deleteindex( ) function.

Using the MDNA index 155, a subscribing data source may retrieve information on customers stored in other data sources. FIG. 4 illustrates the steps performed to retrieve information on a customer from other data sources. The process starts when a requesting system transmits 402 a data storage ID and a customer ID to the CDNA system 145. At steps 405 and 410, the CDNA system 145 checks the data storage ID to determine whether the requesting system is an authorized system. If the requesting system is not an authorized system, i.e., “NO” at step 410, the CDNA system 145 denies access to the requesting system at step 415. If the requesting system is an authorized system, i.e., “YES” at step 410, the CDNA system 145 checks the customer ID to determine whether the customer ID exists in the MDNA index 155 at step 420. If the customer ID does not exists in the MDNA index 155, i.e., “NO” at step 425, then the CDNA system 45 returns an error message to the requesting system.

If the customer ID exists in the MDNA index 155, i.e., “YES” at step 425, then the CDNA system 145 cross references the customer ID to determine the CDNA ID for the customer at step 435. The MDNA index 145 is then queried at step 440 to determine if other customer IDs for different data sources exist for the customer having the CDNA ID determined at step 435. If other customer IDs exist, i.e., “YES” at step 445, then the CDNA system 145 returns a list of customer IDs and corresponding data storages IDs to the requesting system at step 455. Otherwise, the CDNA system may return a response indicating that no other customer IDs exist at step 450. An exemplary program specification for performing the above steps is illustrated in the appendix by a getindex( ) function.

As discussed above, the MDNA index 155 may cross-reference the CDNA IDs of customers with other core information (e.g., name, address, etc.) regarding the customer. A data source 115, 125, 135 may transmit information to the CDNA system 145 to request a change of this core information. For example, if a customer's address changes, a data source may transmit a request to the CDNA system 145 to update the customer's address in the MDNA index 155. The CDNA system appends the updated information to the customer data already existing for this customer's CDNA ID and cross-referenced in the MDNA index. This allows the CDNA system to increase its information regarding the customer and thereby improve the ability to match customer information among separate data sources. An exemplary program specification for performing the above steps is illustrated in the appendix by a modifycustomer( ) function.

Other embodiments of the invention will be apparent to those skilled in the art from consideration of the specification and practice of the invention disclosed herein. By way of example, embodiments of the invention can be advantageously applied to the travel industry so as to provide ready access to customer information for CRM or the like. Segments of the travel industry that could benefit from the system and method of the claimed invention include airlines, railway travel providers, ground transportation providers, water-based travel providers, hotels, rental car agencies and the like.

In this regard, airline CRM makes use of an extension of Customer DNA, that illustrates its power and extensibility in an airline customer service application. This extension uses an indexing system that allows airlines to evaluate a traveler's data through the entire service supply chain. The data sources 115, 125 and 135 of specific applications supply database index information into a central location, the Customer DNA database 145, for rapid evaluation and access across multiple technology platforms. The Customer DNA system and its MDNA index 155 makes the technology platform of the specific applications and their respective data sources a non-constraint. For example, the CDNA system can appropriately index customer information stored in a first data source that operates in a Windows®/Oracle® environment, a second data source that operates in a UNIX/DB2 environment and a third data source that operates in a transaction processing facility (TPF) environment. The Customer DNA system and its MDNA index allow access to the various customer/traveler databases in and outside of the environment maintaining the CDNA data, thus giving a consolidated view of a customer/traveler. The common link that will enable this consolidation of customer data is the Customer DNA ID, which is a unique number assigned to each individual customer/traveler.

When a record containing traveler information is created anywhere within the environment 100, whether it is a passenger name record (PNR) record, a ticket record, a profile record, or a Frequent Traveler Awards record; whether in TPF or in Unix; whether derived or a direct feed, the traveler information can be indexed into the Customer DNA system 145 and associated with a Customer DNA ID that either: (i) is newly generated or (ii) previously existed in association with other entries in the same or a different data source for the same customer. As described above, the Customer DNA ID or number, along with the prime key information from where the record originated will be indexed into the Customer DNA system. The prime key information for each entry into the CDNA system includes the customer ID utilized by the respective data source, such as a frequent traveler (FQTV) number for the frequent travelor data source, a relationship management system (RMS) ID for the RMS data source or the like, as well as an identification of the respective data source. The Customer DNA system will comprise disparate index records in the Master DNA Index 155, that is, the cross-reference keys to access the information from all the databases containing customer/traveler information. This effectively will provide multiple access paths into the customer DNA system.

In effect, a Customer DNA system has features of data warehousing except not in a centralized location. This non-centralized feature allows platform independence, thus allowing legacy system extensions with minimal enhancements while still permitting the various different types of customer information to be linked together. In this regard, the Customer DNA system allows a holistic view of the traveler across the entire travel value chain/experience but at the same time allows single topic views on the traveler. For example: how many airline trips has a traveler made on all airlines; how many Customer Service incidents has a traveler experienced on a specific airline; how many and for what topics did the traveler contact the airline/travel agency/call center; how many visits did the traveler make to the travel agency's web site and for what purpose?

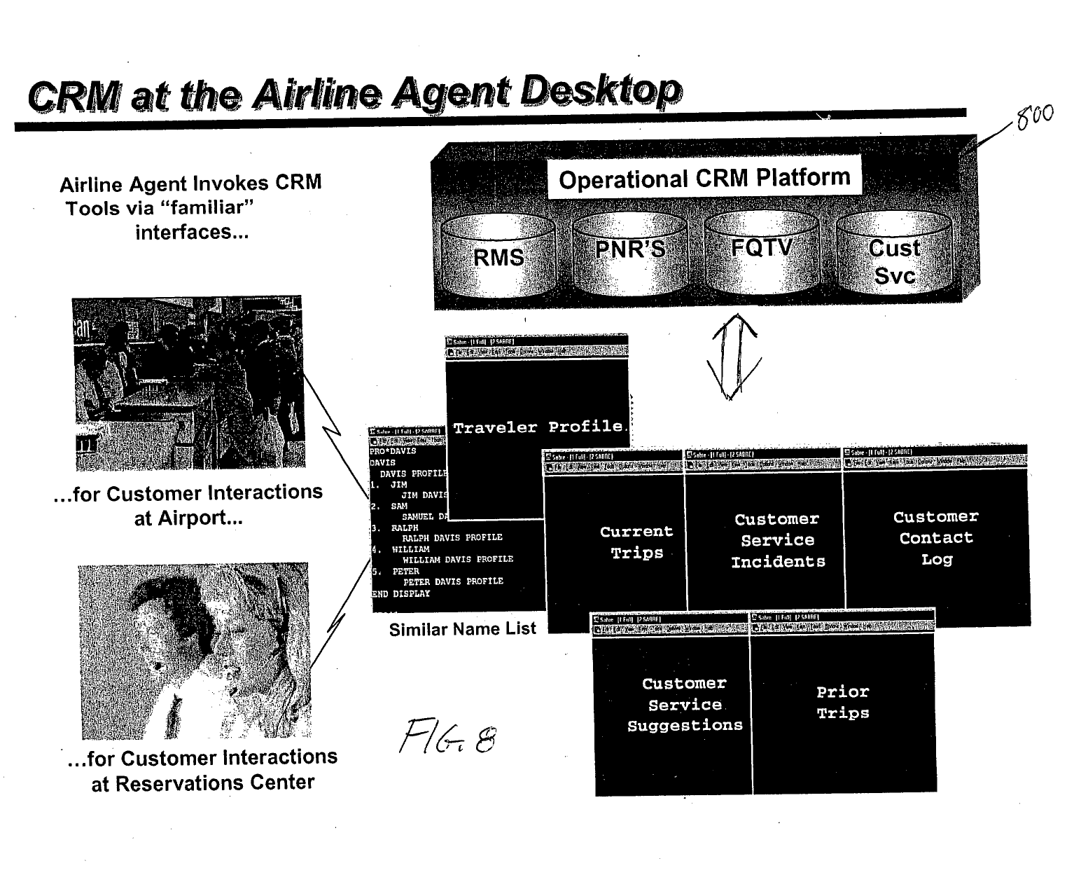

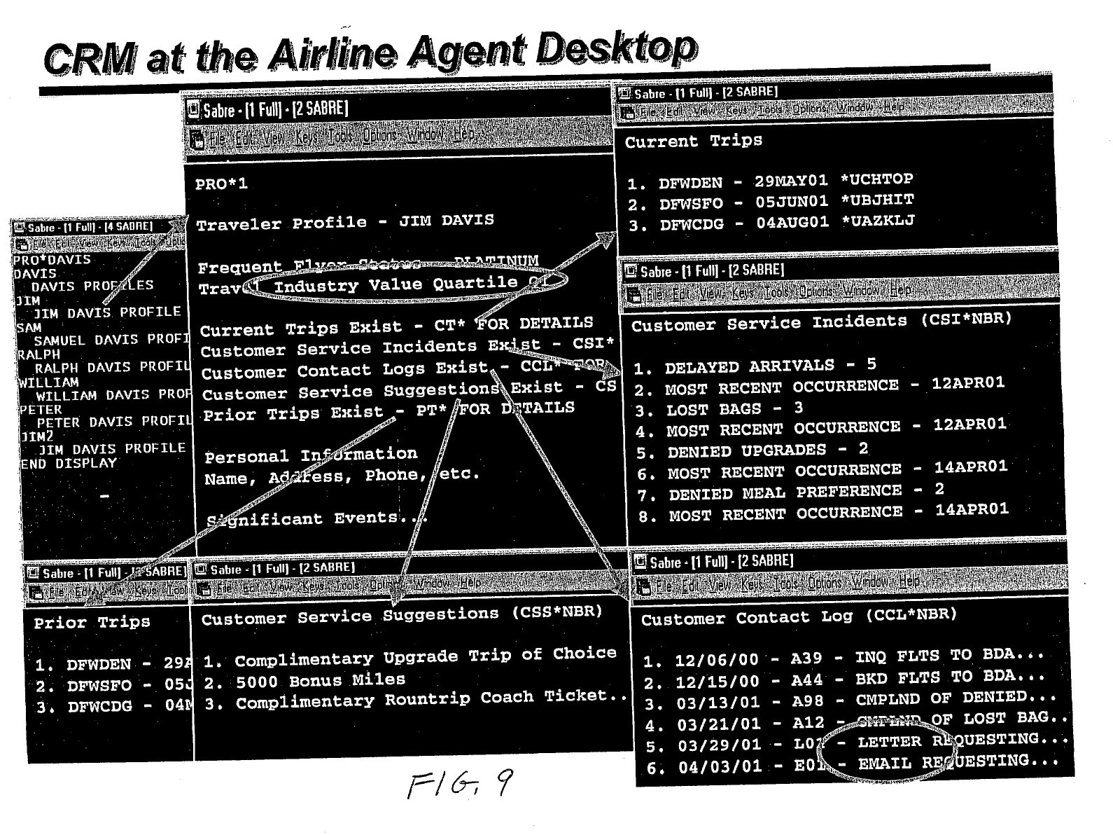

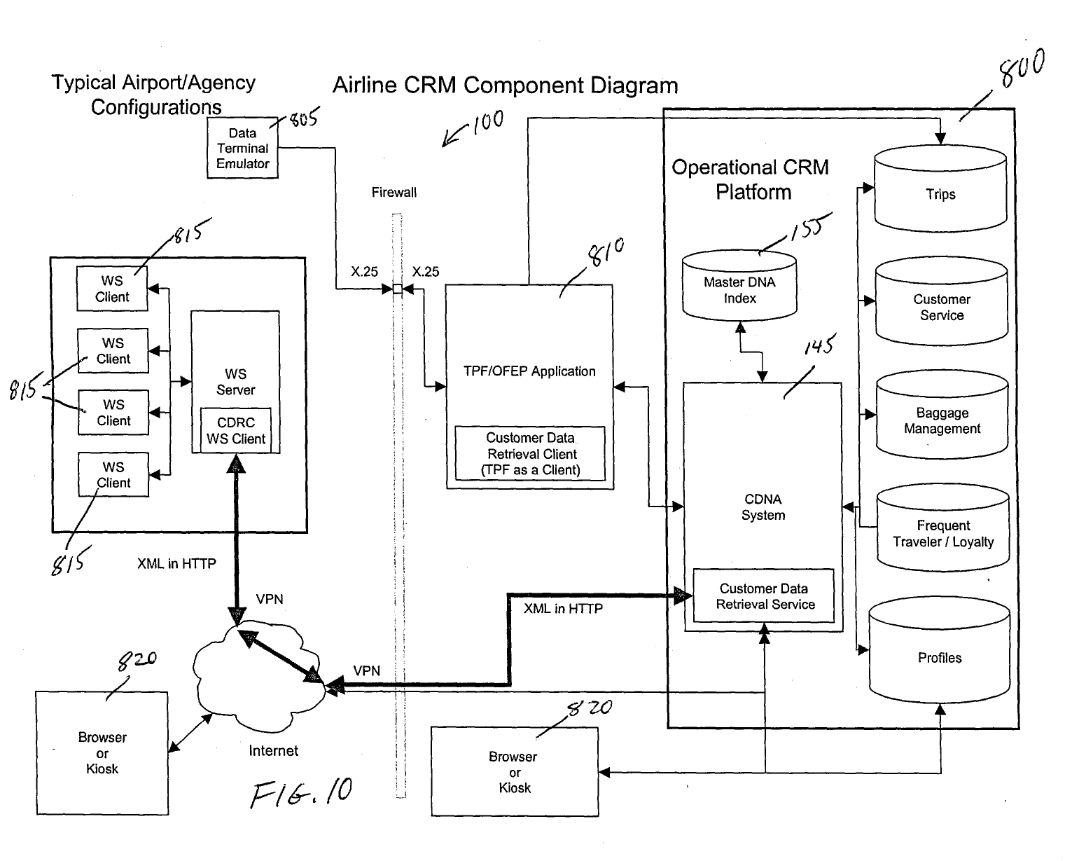

FIGS. 8 and 9 depict a number of data sources 115, 125 and 135 that may store different types of information regarding the same customers. The customer information may be utilized for various purposes including by airline customer service agents to obtain an integrated, comprehensive view of all available customer information via one simple, easy to use interface. And data duplication, a major airline concern, is eliminated by the CDNA system 145. Example information that can be provided in real-time or near real time to the agent's fingertips includes: traveler profiles, current trips, prior trips, customer service incidents, customer contact logs, customer service suggestions and pre-scripted customer service talking points. Each of these different types of customer information may be stored in a separate data source on a different platform, such as the RMS data source, the PNR data source, the FQTV data source and the customer service data source, but are cross-referenced and integrated by the CDNA system. As shown in more detail in FIG. 9, the customer information may be accessed by customer ID. In this regard, a traveler profile in a data source, such as an RMS data source or, more generically, a profiles data source, may be provided which, in turn, cross-references other types of customer information, such as current trips by the same traveler, prior trips by the same traveler, customer service incidents involving the traveler, customer contact log and customer service suggestions for the traveler. By way of example with reference to FIG. 10, the current and prior trips by the traveler may be stored in a Trips database, while the customer service incidents involving the traveler, customer contact log and customer service suggestions may be stored in a customer service database.

When customer travel related data is added to a database somewhere in the host environment 100 there is a need to track the data. The customer DNA system 145 will enable the host environment to track the distribution of the data by adding a cross-reference item in the MDNA index 155. This is similar to the Dewey decimal card system catalog holding references to where to find a book. In order to associate the customer travel related data with other customer information that has been previously stored for the same customer or, alternatively, to determine that the newly added travel related data is the first information indexed by the CDNA system for the particular customer, the CDNA system employs a matching process as described above based upon the customer name or other identifying information, such as the customer's social security number, frequent flyer number, etc. While various matching processes may be employed, one matching process initially employs a high-level match that will enable a customer to be matched immediately if certain customer information, such as customer name, corresponds to or matches the prime keys associated with other customer information stored within the environment and cross-referenced by the CDNA system. The high level match may involve the definition of windows of acceptability for various types of customer information, such as customer name, customer address, etc. By way of example, the window of acceptability for the customer name may identify as potential matches all customers referenced by the CDNA system who have the same last name and the same first name or the first initial. By way of example, newly added customer information associated with John Smith may be matched at a high level with other customer information indexed by the CDNA system for John Smith, Jon Smith, Jonathan Smith and J. Smith. A deeper, more exhaustive match involving other customer information may subsequently be performed, either immediately following the high level match or at a later time to identify which of the candidates identified by the high level match are actually associated with the same customer.

In one embodiment of the invention, due to the nature of data entered into the TPF environment, (e.g. dirty) name matching may be performed using, among other things, fuzzy or statistical matching to provide the high level match. One skilled in the art would recognize that other types of name matching processes may be employed without departing from the scope of the present invention.

Regardless of the actual name matching technique, there may be several components of a name matching process, which in one embodiment, include data storing and identification.

Data storing may include (1) the extraction of data, (2) the parsing of data into its elements, (3) the cleaning of data, and (4) the standardization of data into a standard form. Data identification may enable a host system, such as the CDNA system 145, to match and merge customers in a data storage environment. Data identification may include (1) the matching of prime data that consists of establishing a high level potential list of candidates for the match and (2) the evaluation of the list of candidates by means of a deeper matching process by using non prime key data and, at least in some instances, weighting the relative contributions of the different types of non prime key data to achieve a “deeper” match.

Accordingly, objectives of the matching process to determine the customer information stored by the various data sources that relate to the same customer may, among other things, involve widening the search to handle errors, using fuzzy match algorithms to determine a match, and narrowing the search to limit the resource overhead. However, other matching processes may be employed, if so desired.

Catching Errors and Similarities

Possible errors may occur from mistyping similar sounding names (e.g., Smyth and Smith), typographical errors, incomplete and/or duplicate names. To overcome this, a phonetic algorithm may be employed during the matching process that is configured to reduce, and if not eliminate, any uncertainty associated with the data entries. For example, SMITH becomes SNATH, and SMYTHE becomes SNATH as well. The NYSIIS code for the phonetically represented names is then used as a match criteria.

Optimizing the Algorithm

The SOUNDEX code should produce a similar representation for a given name. There is also a strong correlation between a SOUNDEX code and a NYSIIS code for a given subset of similar names. Methods and systems consistent with certain features related to the present invention may compare the correlation, and when anomalies are found, the algorithm may be optimized to include the anomaly if suitable.

Weighting

The surname and the initials of the customer are stored in sound based format as well as in original-based format. Data in the indexes may be stored in a form that is matchable whereas data in the master record will be stored in original format.

In addition to the customer name, customer records may be matched based upon a variety of different information. Since some of this information may be more informative or statistically influential in the matching process than other information, the matching between different types of customer information may be weighted such that the information that is more significant to the overall matching process is weighted more heavily. In one embodiment, matching field candidates can be a combination of NYSIIS code, Surname, Initials, FirstName, Middle Name, Address (storing the numbers only), Phone number, Soundex group (for initials), and Nickname code. Given the number of fields that may be used, the form of the input, and the form of the stored data, the candidate list is weighted according to the likelihood of a match.

Name Matching Resources and Scheduling

In one embodiment of the invention, the name matching process may include two different processing cycles to determine a match and get a clean “name”. These two cycles may include a lite wash cycle, and a deep clean cycle. The lite wash cycle is a process that employs relatively large windows of acceptability to identify potential or candidate matches.The deep clean cycle is a process that searches the potential or candidate matches identified by the lite wash cycle to identify the actual matches. While the lite wash cycle and the deep clean cycle may be performed at different times or with different frequencies, both the lite wash cycle and the deep clean cycle are generally performed as new customer information is added.

FIG. 10 is a block diagram of an exemplary system environment 100 that may be implemented by certain aspects related to the present invention. As shown, the operational CRM platform 800 includes several different data sources including, but not limited to, a traveler data warehous, such as a Trips data source; a customer service data source; a baggage management data source; a frequent traveler/loyalty program data source; and a Profiles data source, such as an RMS data source. The various data sources are in communication with the CDNA system 145 which includes, among other things, the MDNA index 155. The operational CRM platform may be accessed in various manners. For example, data terminal emulators 805 may access the operational CRM platform via a TPF/OFEP application 810. As used herein, OFEP references an open front end processor and CDRC, as used in FIG. 10, references a customer data retrieval client. In addition, workstation (WS) clients 815, such as those employed by travel agencies, may access the operational CRM platform. Still further, the operational CRM platform may be accessed via a browser application 820, such as via a personal computer or a kiosk, over the internet or otherwise.

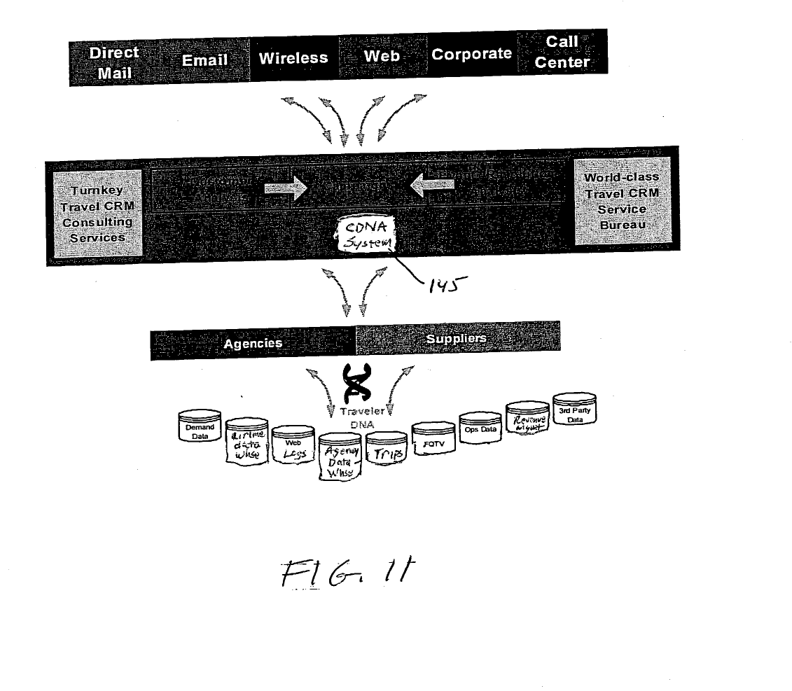

FIG. 11 is a schematic representation of various uses of the customer information. In this regard, a number of different data sources are depicted including demand data, airline data warehouse, web logs, agency data warehouse, trips data, such as PNR data, FQTV data, operational data, revenue management and third party data, such as data purchased from a third party. As shown, the customer information is provided by and utilized by travel agencies and airlines. For example, the CDNA system 145 may permit customer analysis and event resolution analysis to facilitate travel CRM consulting services and the operation of travel CRM service bureau. Additionally, the customer information may be utilized for targeted marketing via various media, including via direct mail, email, wireless transmission, web-based communications, corporate and call centers.

Accordingly, methods and systems consistent with certain features related to the present invention enable travel-based systems to implement the CDNA features of the invention (described above) to perform customer relationship management operations in the travel industry. The decentralized data warehousing features of the present invention enable multiple types of platforms to be used to provide quick and accurate access to travel customer information for systems and entities associated with any type of travel (e.g., airlines, railway travel providers, ground transportation systems, water-based travel providers, etc.). For example, as shown in FIGS. 8 and 9, an airline agent may have access to various types of customer information that may be located in remote systems operating in different platforms and configurations. Using various CDNA aspects of the present invention, the airline agent may obtain the customer information quickly and accurately.

The configuration of the system environment 100 shown in FIG. 10 is not intended to be limiting. For example, the use of various types of networks and network interfaces may be implemented without departing from the scope of the present invention. Also, as shown in FIG. 11, methods and systems related to certain features of the present invention use various mediums to communicate information between the host environment, customers, travel agents, and any other type of entity that may use or provide travel customer information.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

[image]

[image]

[image]

[image]

[image]

[image]

[image]

[image]

[image]

[image]

[image]

[image]

[image]

[image]

What is claimed is:

1. A method for sharing travel-based information among a plurality of systems, comprising:
receiving travel-based information associated with and identifying a traveler from a storage system;
determining whether an identifier exists in a master data store for the traveler based on the travel-based information identifying the traveler; and
associating an identifier with the traveler based on a result of the determination;
and cross-referencing the identifier with the travel-based information.

2. The method according to claim 1, wherein the travel-based information includes at least one of a travel profile, current trip information, customer service incident information, customer contact log data, customer service suggestion information, and prior trip information associated with the traveler.

3. The method according to claim 1, further comprising:
retrieving travel-based information from the master data store based on the identifier.

4. The method according to claim 1, wherein the travel-based information includes a storage identifier to identify an electronic storage facility transmitting the travel-based information, a traveler identifier for identifying traveler information in the electronic storage facility; and traveler data for matching a traveler with existing travelers in the master data store.

5. The method according to claim 1, wherein cross-referencing comprises:
creating a record in a table having first and second fields, wherein the first field stores the identifier and the second field stores the travel-based information.

6. A computer for sharing travel-based information among a plurality of electronic storage facilities, the computer comprising:
a memory having program instructions; and
a processor, responsive to the program instructions, configured to:
receive travel-based information associated with and identifying a traveler from an electronic storage facility;
determine whether an identifier exists in a master data store for the traveler based on the travel-based information identifying the traveler;
associate an identifier with the traveler based on a result of the determination; and
cross-reference the identifier with the travel-based information.

7. The computer according to claim 6, wherein the travel-based information includes at least one of a travel profile, current trip information, customer service incident information, customer contact log data, customer service suggestion information, and prior trip information associated with the traveler.

8. The computer according to claim 6, wherein the processor is further configured to:
retrieve travel-based information from the master data store based on the identifier.

9. The computer according to claim 6, wherein the travel-based information includes a storage identifier to identify an electronic storage facility transmitting the travel-based information, a traveler identifier for identifying traveler information in the electronic storage facility; and traveler data for matching a traveler with existing travelers in the master data store.

10. The computer according to claim 6, wherein the processor cross-references the identifier with the travel-based information by creating a record in a table having first and second fields, wherein the first field stores the identifier and the second field stores the travel-based information.

11. A system for sharing travel-based information, the system comprising:
a plurality of electronic storage facilities for storing travel-based information associated with and identifying a traveler; and
a CDNA system for receiving travel-based information from an electronic storage facility, said CDNA system comprising a master data store and being capable of determining whether an identifier exists in the master data store for the traveler based on the travel-based information identifying the traveler, said CDNA system further capable of associating an identifier with the traveler based on a result of the determination and cross-referencing the identifier with the travel-based information within the master data store.

12. The system according to claim 11, wherein the travel-based information includes at least one of a travel profile, current trip information, customer service incident information, customer contact log data, customer service suggestion information, and prior trip information associated with the traveler.

13. The system according to claim 11, wherein said CDNA system is further configured to:
retrieve travel-based information from the master data store based on the identifier.

14. The system according to claim 1 1, wherein the travel-based information includes a storage identifier to identify said respective electronic storage facility transmitting the travel-based information, a traveler identifier for identifying traveler information in said electronic storage facility; and traveler data for matching a traveler with existing travelers in the master data store.

15. The system according to claim 11, wherein said CDNA system cross-references the identifier with the travel-based information by creating a record in a table within the master data store having first and second fields, wherein the first field stores the identifier and the second field stores the travel-based information.

16. A method for sharing travel-based information among a plurality of systems, comprising:
receiving an inquiry for travel-based information associated with a traveler;
determining whether an identifier exists in a master data store for the traveler based on the travel-based information identifying the traveler; and
providing access to travel-based information associated with the traveler and stored in a respective one of a plurality of storage systems based upon the identifier for the traveler and the travel-based information cross-referenced by the master data store to the identifier.

17. The method according to claim 16, wherein the travel-based information includes at least one of a travel profile, current trip information, customer service incident information, customer contact log data, customer service suggestion information, and prior trip information associated with the traveler.

18. A system for sharing travel-based information, the system comprising:
a plurality of electronic storage facilities for storing travel-based information associated with and identifying a traveler; and
a CDNA system for receiving an inquiry for travel-based information associated with a traveler, said CDNA system comprising a master data store and being capable of determining whether an identifier exists in the master data store for the traveler based on the travel-based information identifying the traveler, and said CDNA system providing access to travel-based information associated with the traveler and stored in a respective one of said plurality of storage systems based upon the identifier for the traveler and the travel-based information cross-referenced by the master data store to the identifier.

19. The system according to claim 18, wherein the travel-based information includes at least one of a travel profile, current trip information, customer service incident information, customer contact log data, customer service suggestion information, and prior trip information associated with the traveler.
